(19) United States
(12) Patent Application Publication
(10) Pub. No.: US 2006/0118154 A1
(43) Pub. Date: Jun. 8, 2006

(54) Crutches that convert into canes and methods for conversion of same

(75) Inventor: Amy B. David, Evanston, IL (US)

Correspondence Address: JENKENS & GILCHRIST, P.C., 225 WEST WASHINGTON, SUITE 2600, CHICAGO, IL, 60606, US

(73) Assignee: Medline Industries, Inc.

(21) Appl. No.: 11/246,504

(22) Filed: Oct. 7, 2005

Related U.S. Application Data
(60) Provisional application No. 60/630,913, filed on Nov. 24, 2004.

(51) Int. Cl. A61H 3/02

(52) U.S. Cl. 135/72; 135/76

(57) ABSTRACT

The present invention is directed to a crutch/cane assembly that can be converted from a crutch into a cane, or vice-versa. The crutch/cane assembly has first and second elongated members, an arm support connected to the upper portions of the first and second elongated members, and an inner member connected to the first and second elongated members on opposing sides of the inner member. A removable cane member has a grip having a first and second end where at least one of the first and second ends is removably attached to the first and second elongated members, and at least one hole. A foot member is telescopically inserted into the inner member and the removable cane member, and detachably connected to the cane member via at least one spring-loaded pin that is inserted into at least one hole of the removable cane member.

### CROSS-REFERENCE TO RELATED APPLICATIONS

This application claims the benefit of priority of U.S. Provisional Patent Application No. 60/630,913, filed Nov. 24, 2004, which is hereby incorporated by reference in its entirety.

### FIELD OF THE INVENTION

The present invention relates generally to aids for walking, and, more particularly, to crutches that convert into canes. Furthermore, the present invention relates to methods for converting crutches into canes.

### BACKGROUND OF THE INVENTION

Devices to assist in walking have been known in the prior art. Specifically, crutches and canes have been used to provide support for persons who are not capable of walking on their own or who need some assistance in getting from one location to another.

As is often the case, persons using such devices may chose to use one form, i.e., either a crutch or a cane, at first, and then transition to the other form. This requires that a person purchase and use two distinct devices. Combining a crutch and a cane into a single unit is advantageous as a person need only purchase only the single unit rather than multiple devices. Furthermore, a single unit containing a crutch and a cane is advantageous as a person will not have to transport two separate devices where he or she wants the option of having both the crutch and the cane available for use.

In the past, crutches that have converted into canes have typically employed the underarm support of the crutch as the grip of the cane upon conversion. Use of the underarm support of the crutch as the grip of the cane has disadvantages. The grip of a cane generally needs to be made from a durable material such that repeated and often strenuous use of the grip will not result in the grip becoming misformed or damaged. The underarm support, in contrast, is generally difficult to grip. The material that is used for the underarm support is meant to provide a comfortable means of supporting the user while using the crutch and it not intended for gripping. The underarm support may contain a lot of padding to make the support more comfortable. In fact, users quite often add padding to the underarm support in an effort to decrease the discomfort associated with using a crutch. This situation is even less desirable where the underarm support is used as the grip of the cane as the increased padding makes it difficult for a user to grasp and use the grip for any period of time. Thus, a crutch that has an underarm support that converts into the grip of a cane must either sacrifice comfort or gripability.

Crutches that have converted into canes have also had other problems. In the past, users of prior crutches that have converted into canes have had problems with alignment of the crutch. In other words, the crutch may not be aligned in a manner that is helpful to the user or that makes use of the crutch an unpleasant experience. Improper alignment of the parts of the crutch may cause users to feel unstable, and users may, out of a fear of falling, fail to use the crutch when needed.

Therefore, there is a need for a crutch that converts into a cane whereby the underarm support and the grip of the cane are separate parts, and, once converted, the underarm support of the crutch is not used for the grip of the cane. Additionally, there is a need for a crutch that converts into a cane in which all parts of the cane are in alignment when being used. The present invention is directed to providing a device to overcome the above disadvantages.

### SUMMARY OF THE INVENTION

In one aspect of the present invention, an adjustable crutch that converts into a cane includes a first elongated member and a second elongated member. Each elongated member has an upper portion and a lower portion. The upper portions of the first and second elongated members are in parallel alignment and separated by a grip. The upper portions are connected to opposite ends of an arm support. The lower portions of the first and second elongated members have a converging pair of angular bends which bring the lower portions of the first and second elongated members into parallel alignment with an inner member. The inner member is connected to the lower portions of the first and second elongated members such that the lower portions of the first and second elongated,members are on opposing sides of the inner member. The adjustable crutch that converts into a cane also includes a removable cane member that has a top portion and a bottom portion. The top portion includes the grip. The grip has a first end and a second end. At least one of the first and second ends of the grip is removably attached to the upper portion of the first and second elongated members. The bottom portion of the removable cane member has at least one hole. The adjustable crutch that converts into a cane also has an adjustable foot member that is telescopically inserted into the inner member and the removable cane member. The foot member has at least one spring-loaded pin and detachably connects to the bottom portion of the cane member via at least one of the spring-loaded pins that is inserted into at least one of the holes in the bottom portion of the removable cane member.

In another aspect of the present invention, a method for converting an adjustable crutch into a cane includes providing a crutch/cane assembly that has a first elongated member and a second elongated member. Each elongated member has an upper portion and a lower portion. An arm support connects to the upper portions of the first and second elongated members. An inner member connects to the lower portions of the first and second elongated members such that the lower portions of the first and second elongated members are on opposite sides of the inner member. The crutch/cane assembly includes a removable cane member which has a grip. The grip has a first end and a second end. At least one of the first and second ends of the grip is removably attached to the first and second elongated members. The removable cane member has at least one hole. The crutch/cane assembly also includes an adjustable foot member that has at least one spring-loaded pin. The adjustable foot member is telescopically inserted into the removable cane member and the inner member and connects to the removable cane member via at least one of the spring-loaded pins that is inserted into at least one of the holes in the removable cane member. The method further includes removing the foot member from the crutch/cane assembly by releasing at least one spring-loaded pin from at least one of the holes in the removable cane member. The method also includes removing the cane member from the crutch/cane assembly by disengaging the grip of the removable cane member from the first and second elongated members and telescopically inserting the foot member into the cane member and attaching the foot member therein by inserting at least one of the spring-loaded pins into at least one of the holes in the cane member.

In an alternative aspect of the present invention, a crutch that converts into a cane includes a crutch component that has a first elongated member and a second elongated member. Each elongated member has an upper portion and a lower portion. An arm support connects to the upper portions of the first and second elongated members. An inner member connects to the lower portions of the first and second elongated members such that the lower portions of the first and second elongated members are on opposing sides of the inner member. The crutch that converts into a cane further includes a removable cane component that has a top portion and a bottom portion. The top portion has a grip. The grip has a first end and a second end. At least one of the first and second ends of the grip is removably attached to the upper portions of the first and second elongated members. The bottom portion of the removable cane component has at least one hole. Additionally, the crutch that converts into a cane includes a removable foot component that is capable of being telescopically inserted into the inner member and the cane component. The foot component has at least one spring-loaded pin and is detachably connected to the bottom portion of the cane component via at least one spring-loaded pin that is inserted into at least one hole in the bottom portion of the removable cane component.

In an alternative aspect of the present invention, an adjustable crutch that converts into a cane includes a first elongated member and a second elongated member. Each member has an upper portion and a lower portion. An arm support connects to the upper portions of the first and second elongated members such that the upper portions are on opposing sides of the arm support. An inner member connects to the lower portions of the first and second elongated members such that the lower portions are on opposing sides of the inner member. The adjustable crutch that converts into a cane also includes a removable cane member that has a top portion and a bottom portion. The top portion has a grip. The grip has a first end and a second end. At least one of the first and second ends of the grip removably attaches to the first and second elongated members by a removable attaching means. The bottom portion of the cane member has at least one hole. The inner member and the bottom portion of the cane member are adapted for telescopically receiving a foot member. The foot member has a means for detachably connecting the foot member to the bottom portion of the cane member.

In an alternative aspect of the present invention, a method for converting the adjustable crutch described above into a cane includes removing the cane member by releasing the removable attaching means to remove the grip from the first and second elongated members. The method further includes removing the foot member from the inner member and the cane member by releasing the means for detachably connecting the foot member to the bottom portion of the cane member and telescopically inserting the foot member into the cane member.

In an alternative aspect of the present invention, a method for forming an adjustable crutch includes providing a first elongated member and a second elongated member. Each member has an upper portion and a lower portion. The upper portions of the first and second elongated members are connected to an arm support. The lower portions of the first and second elongated members are connected to an inner member such that the lower portions of the first and second elongated members are on opposing sides of the inner member. The method for forming an adjustable crutch includes providing a cane member that has a top portion and a bottom portion. The top portion includes a grip that has a first end and a second end. The bottom portion has at least one hole. The method further includes removably attaching at least one of the first and second ends of the grip of the cane member to the upper portions of the first and second elongated members, telescopically inserting a foot member into the inner member and the bottom portion of the cane member, and detachably connecting the foot member to the cane member.

In an alternative aspect of the present invention, a crutch that converts into a cane includes a crutch component that has first and second elongated members. The crutch component includes an arm support connecting the first and second elongated members. The elongated members connects on opposing sides to an inner member. The inner member has at least one hole. The crutch that converts into a cane also includes a removable cane component that has a top portion and a bottom portion. The top portion includes a grip that has a first end and a second end. At least one of the first and second ends removably attaches to the first and second elongated members by an attaching means. The bottom portion of the cane component has at least one hole. The crutch that converts into a cane further includes a removable foot component that is capable of being telescopically received by the inner member and the cane component.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 shows a pictorial view of a human form with the convertible crutch/cane assembly in operating position according to one embodiment of the present invention.

FIG. 2 shows a perspective view of the convertible crutch/cane assembly according to one embodiment of the present invention.

FIG. 3 shows a perspective view of the removable cane member according to one embodiment of the present invention.

FIG. 4 shows a perspective view of the removable foot member according to one embodiment of the present invention.

FIGS. 5 and 6 show perspective views of the bolt and wing nut, respectively, according to one embodiment of the present invention.

FIG. 7 shows a perspective view of the spring-loaded pin according to one embodiment of the present invention.

FIG. 8 shows a perspective view of the convertible crutch/cane assembly according to another embodiment of the present invention.

FIG. 9 shows a perspective view of a multi-pod base according to one embodiment of the present invention.

FIG. 10 shows a perspective view of a base with metal prongs according to one embodiment of the present invention.

FIG. 11 shows a perspective view of a ball-and-socket joint according to one embodiment of the present invention.

FIG. 12 shows an exploded view of the convertible crutch/cane assembly according to one embodiment of the present invention.

FIG. 13 shows a pictorial view of a human form with the cane assembly in operating position according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DESCRIPTION OF ILLUSTRATIVE EMBODIMENTS

The present invention is directed to a crutch that can be converted into a cane for persons requiring assistance in walking. The crutch has portions which are removable therefrom and which are easily assembled into a cane by a user.

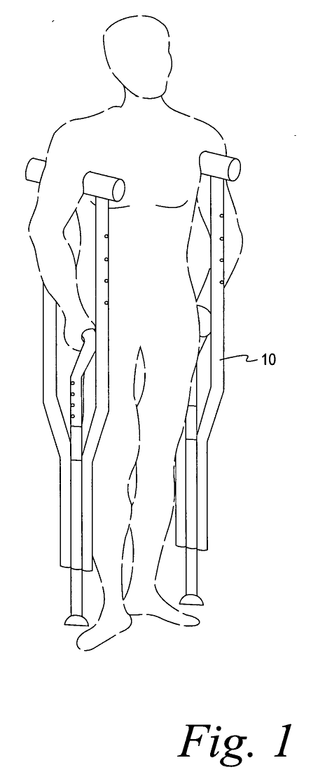

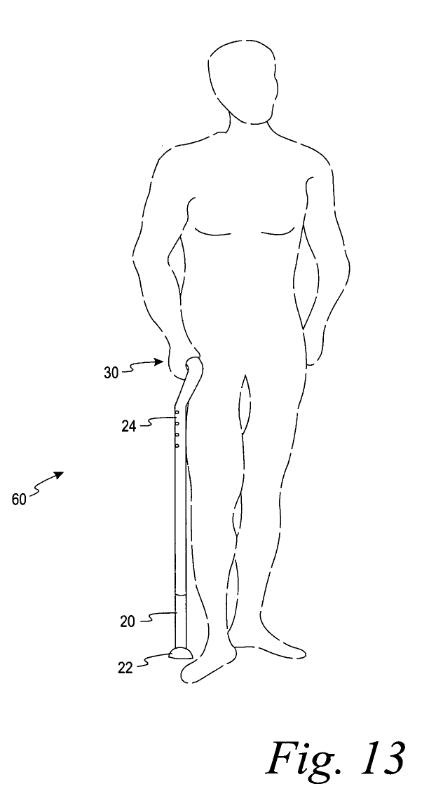

FIG. 1 shows a crutch/cane assembly 10 according to the present invention. When a user is using the crutch/cane assembly 10 as a crutch, the user positions the crutch/cane assembly 10 as shown in FIG. 1. Thus, in FIG. 1, the user is using the cane/crutch assembly 10 in “crutch mode.” For comparison with FIG. 1, FIG. 13 shows the crutch/cane assembly 10 after it has been converted into a cane and is being used in “cane mode.”

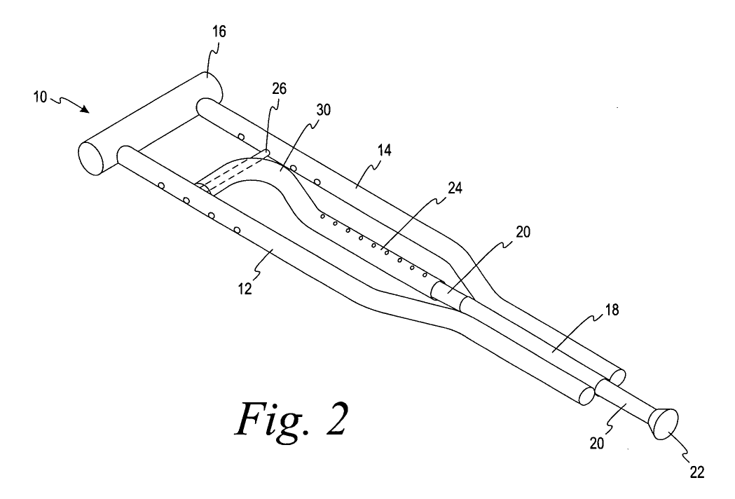

As shown in FIG. 2, the crutch/cane assembly 10 includes a first elongated member 12 and a second elongated member 14, each having a top portion and a bottom portion. The top portions of the first and second elongated members 12, 14 are straight, vertically-parallel members, separated by a grip 30. The top portions of the first and second elongated members 12, 14 are connected to opposite ends of an arm support 16, such that the upper ends of the first and second elongated members 12, 14 are contained within the arm support 16, and are maintained there by screws or other connecting means. Alternatively, the first and second elongated members 12, 14 may be secured to the arm support 16 by welding. The top portions of the first and second elongated members 12, 14 may contain holes or openings 15 that are used for attaching the grip 30. The holes 15 may be diametrically-opposed pairs of holes or alternating holes. It is contemplated that the diametrically-opposed holes are positioned on opposing sides of a member such that the holes 15 are opposite one another. It is further contemplated that alternating holes are positioned on opposing sides of a member such that the holes 15 are not opposite one another and are instead in a diagonal relationship to one another.

The bottom portions of the first and second elongated members 12, 14 have a converging pair of angular bends which bring the first and second elongated members 12, 14 into a parallel relationship along opposite sides of an inner member 18. The bottom portions of the first and second elongated members 12, 14 may be secured to the inner member 18 by a bolt or rivet extending through the first and second elongated members 12, 14 and the inner member 18. Alternatively, the first and second elongated members 12, 12 and the inner member 18 may be welded together. The first and second elongated members 12, 14 and the inner member 18 may also be inserted into a collar that holds the first and second elongated members 12, 14 and the inner member 18 together. The collar may be made of plastic, metal or combinations thereof or any other suitable material. In addition to the securing means described herein, other suitable means of securing the first and second elongated member 12, 14 and the inner member 18 that are known in the art can be used in embodiments of the present invention.

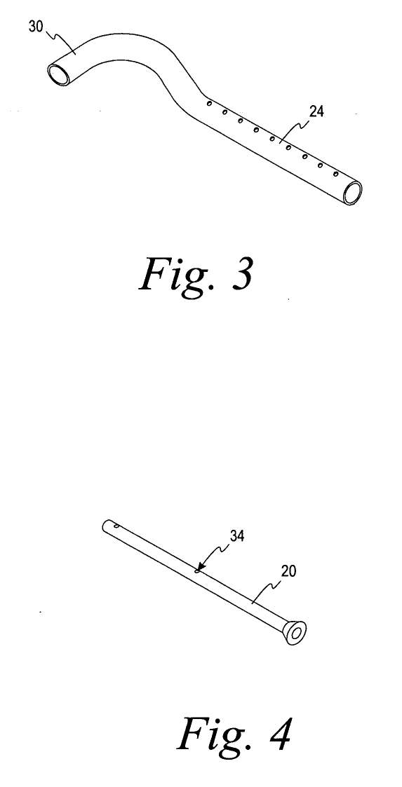

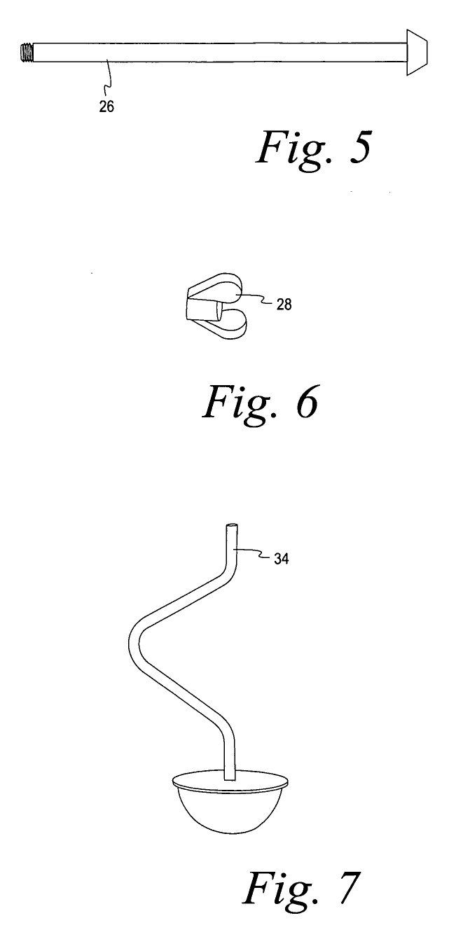

The crutch/cane assembly 10 also includes a cane member 24 (also shown in FIG. 3) and a foot member 20 (also shown in FIG. 4). The upper portion of the cane member 24 includes a grip 30 having a first end and a second end that are connected to the first and second elongated members 12, 14 using a bolt 26 (see FIG. 5) and wing nut 28 (see FIG. 6) combination. The bolt 26 is capable of being inserted through one of the holes 15 in the first or second elongated members 12, 14, through holes in the grip 30, and into the diametrically-opposed hole 15 contained in the other of the first or second elongated member 12, 14. The wing nut 28 can then be applied to the end of the bolt 26 to secure it within the holes of the first and second elongated members 12, 14 and within the holes of the grip 30. The grip can be vertically adjusted up or down between the first and second elongated members 12, 14 by removing the bolt 26 and the wing nut 28 and inserting the bolt 26 into other hole(s) 15 to adjust for an individual user's arm length while in crutch mode.

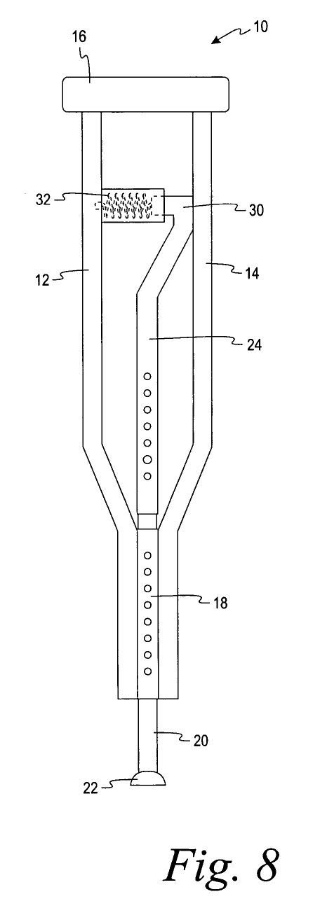

Alternatively, the grip 30 may be connected to the first and second elongated members 12, 14 via a spring-loaded device 32, as shown in FIG. 8. The spring-loaded device 32 may be a part of or separate from the grip 30. The spring-loaded device 32 operates to hold the grip between the first and second elongated members 12, 14 by securing at least one end of the grip 30 to one of the first or second elongated members 12, 14. The other end of the grip 30 may be held adjacent to the other first or second elongated member 12, 14 due to the force of the spring-loaded device and the frictional force between the rubber grip 30 and the non-rubber surface of the first or second elongated member 12, 14. In an alternative embodiment, the other end of the grip 30 may be removably attached to the other first or second elongated member 12, 14 via an attaching means that secures the end of the grip 30 to the other first or second elongated member 12, 14.

In one embodiment, as shown in FIG. 8, the user can disengage the spring-loaded device 32 to remove or adjust the grip 30 by pulling the grip 30 toward the second elongated member 14 to release it from the first elongated member 12, and then rotating the grip 30 such that it is removed from the first and second elongated members 12, 14. The grip 30 with the spring-loaded device 32 can then be moved up or down the first and second elongated members 12, 14 to adjust to the arm length of a user of the crutch/cane assembly 10. In addition to the attaching means described above, other suitable fasteners or means of attachment known in the art can be used in embodiments of the present invention.

The lower portion of the cane member 24 has holes or openings 25 that are formed therein. The holes 25 may be positioned such that they are diametrically-opposed on opposing sides of the cane member 24. There may be one, two or more sets of diametrically-opposed holes 25 that are periodically positioned in a longitudinal manner along the length of the cane member 24. In another embodiment, the holes 25 are alternating holes on opposing sides of the cane member 24 such that the holes 25 are not diametrically-opposed. The placement of the diametrically-opposed or alternating holes 25 may, for example, be ½ inch, 1 inch, or 2 inches apart, or any other appropriate length. The holes 25 are shaped and positioned to receive a spring-loaded pin 34 (FIG. 7) which enables the crutch/cane assembly 10 to be adjusted to the height of a user. Alternatively, a bolt 26 and wing nut 28 combination may be used wherein the bolt 26 is inserted through one pair of the diametrically-opposed holes 25 in the cane member 24 and the wing nut 28 is then applied to the end of the bolt 26 to secure it within the cane member 24. Other devices or means of attachment known in the art can be used in embodiments of the present invention.

The cane member 24 and inner member 18 are capable of telescopically receiving a foot member 20. The foot member 20 may include at least one spring-loaded pin 34. The spring-loaded pin(s) may be located on opposites sides of the foot member 20, in either a diametrically-opposed or alternating position. The foot member 20 can be inserted into the inner member 18 and up into the cane member 24. The spring-loaded pins 34 of the foot member 20 can be inserted into at least one of the holes 25 of the cane member 24. Once inserted, the spring-loaded pins remain in place to keep the crutch/cane assembly 10 intact while in use. The spring-loaded pins 34 can be released by applying pressure to the pins until they are disengaged from the holes 25 in the cane member 24. The foot member 20 can then be moved up or down within the inner member 18 and the cane member 24 to re-insert the spring-loaded pins 34 in different holes 25 to adjust to the height of a crutch user. Once re-inserted, the spring-loaded pins 34 will remain in place until a user wishes to readjust the crutch/cane assembly 10 or to convert the crutch/cane assembly into a cane for use in cane mode. In alternative embodiments, the foot member 20 may be attached to the cane member 24 using a bolt 26 and wing nut 28 combination.

In some embodiments, the inner member 18 may also contain at least one hole 35 that is formed therein, as shown in FIG. 8. The holes 35 may be positioned such that they are diametrically-opposed on opposing sides of the inner member 18. There may be one, two or more sets of diametrically-opposed holes 35 that are periodically positioned in a longitudinal manner along the length of the inner member 18. In another embodiment, the holes 35 are alternating holes on opposing sides of the inner member 18 such that the holes 35 are not diametrically-opposed. Although not depicted, the inner member 18 in FIG. 1 could also contain diametrically-opposed or alternating holes 35. The placement of the holes 35 in the inner member 18 may, for example, be ½ inch, 1 inch, or 2 inches apart, or any other appropriate length. In this case, the spring-loaded pins 34 of the foot member 20 may be inserted into both the holes 25 in the cane member 24 and the holes 35 in the inner member 18. Thus, the height of the crutch is capable of being adjusted by moving the foot member 20 within the cane member 24 and the inner member 18 such that the spring-loaded pins 34 engage different hole 25, 35 positions within the inner member 18 and the cane member 24. This is advantageous because having spring-loaded pins 34 inserted at more than one location increases the stability of the crutch/cane assembly 10.

The first and second elongated members 12, 14, the inner member 18, the cane member 24, and the foot member 20 are preferably hollow metal tubes of any suitable diameter for providing both strength and lightness. The metal tubes may be made from aluminum, steel, titanium, combinations thereof or any other suitable material. The arm support 16 includes an arm support cover that is adjacent to and partially surrounds a plastic article for receiving the ends of the elongated members 12, 14. Alternatively, the article for receiving the ends of the elongated members 12, 14 may be metal and the ends of the elongated members 12, 14 can be welded to the article. The arm support cover may be made from petroleum-based rubber, foam rubber or any other suitable material. The arm support cover is designed to provide comfortable support to the user of the crutch. The arm support cover may also include padding to make the arm support 16 even more comfortable for a user.

The grip 30 may be an orthopedic grip designed to fit to the shape of a hand, or alternatively, a smooth cylindrical grip. The grip 30 may include an outer covering that is comprised of a textured rubber material that is stronger and more durable than the rubber of the arm support cover. Preferably, the grip is water resistant. The outer covering may surround a hollow cylinder for receiving a fastener, such as a bolt. The hollow cylinder may be comprised of plastic or any other type of suitable material for receiving a fastener. In one embodiment, the grip is fitted for the size of a user's hand and is smaller than the arm support. Thus, the present invention provides a user the full benefit of a cane with an easily gripable hand piece and a crutch with an arm support that is larger and more comfortable when placed under the arm. A wrist strap (not shown) may also be attached to the grip 30. The wrist strap may be made of any suitable material that allows a user to release the grip 30 of the cane in order to have a free hand but keeps the cane easily graspable when it is needed again.

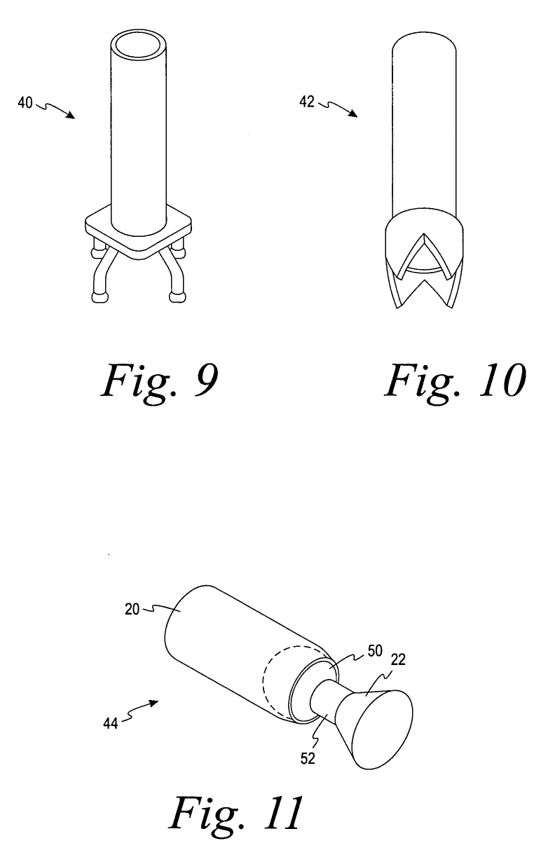

The foot member 20 includes a base 22 on one end that engages with the walking surface. The base 22 of the foot member 20 may be a single or multi-pod foot. FIGS. 1-3 illustrate a crutch/cane assembly 10 with a base 22 that is a single foot. A multi-pod foot 40 is illustrated in FIG. 9. The base 22 may be made of rubber or other flexible or suitable material. The base may include one or more metal prongs 42 for use on ice or slippery surfaces. FIG. 10 illustrates one embodiment of a metal prong 42 with four sharp points. The prongs 42 may be located at or near the end of a single or multi-pod foot.

Alternatively, the foot member 20 may include a ball-and-socket joint 44, as shown in FIG. 11. In this embodiment, the end of the foot member 20 is slightly curved inward to encompass a ball 50 which sits partially within the foot member 20. The ball is welded or otherwise attached to a pin 52 which is connected to the base 22. The ball is capable of rotating within the foot member 20 when an uneven surface is encountered.

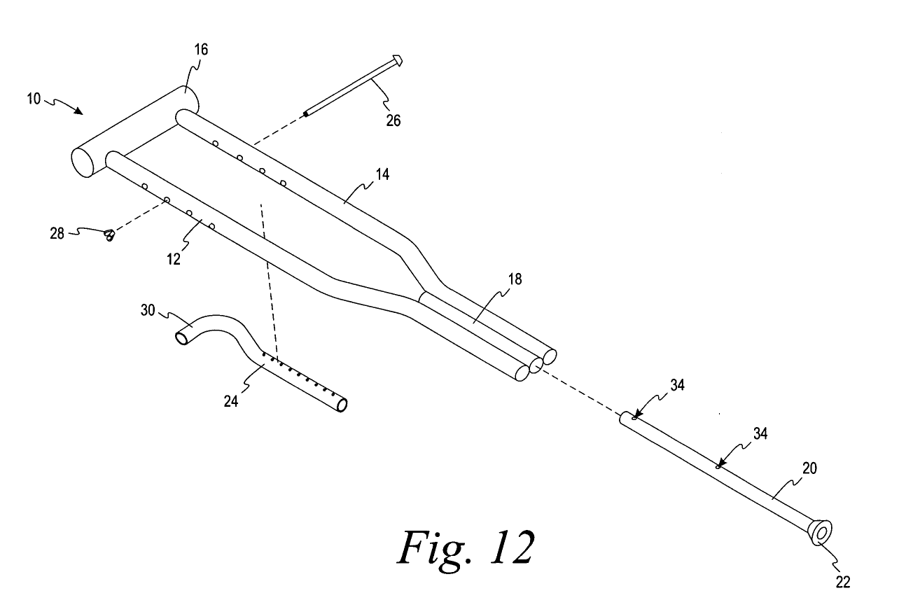

Turning to FIG. 12, the crutch/cane assembly 10 can be disassembled whenever a user decides that he or she wishes to use the cane in cane mode. To disassemble the crutch/cane assembly 10, a user may release the foot member 20 by disengaging the spring-loaded pins 34 from the holes 25 in the cane member 24 (and the inner member 18 if holes 35 are available and are engaged) and then removing the foot member from within the inner member 18 and the cane member 24. Alternatively, a user may release the foot member 20 by disengaging a bolt 26 and wing nut 28 combination or disengaging any other means that has been used to detachably connect the inner member 18 and the cane member 24. The user must also release the grip 30 from the first and second elongated members 12, 14 by either unscrewing the wing nut 28 and removing the bolt 26, or by releasing the spring-loaded device 32 or any other device or means of attachment known in the art. Once the cane member 24 and the foot member 20 are removed from the crutch/cane assembly 10, the foot member 20 can be placed within the cane member 24 to create the cane 60.

FIG. 13 illustrates the cane 60 as it appears after it has been disassembled from the crutch/cane assembly 10 form in crutch mode and reassembled with the cane member 24 and the foot member 20 into a cane for use in cane mode. The foot member 20 can be secured within the cane member 24 by inserting the spring-loaded pins 34 into the holes 25 of the cane member 24 or by using any other connecting device or means of attachment known in the art. The height of the cane 60 can be adjusted by inserting the spring-loaded pins 34 in other (higher or lower) holes 25.

After the cane has been assembled, the cane can be converted back into the crutch/cane assembly 10 for use in crutch mode. To convert the cane back into the crutch/cane assembly 10 while in cane mode, the cane can be disassembled by releasing the spring-loaded pins or other means of connecting the foot member 20 and the cane member 24 and removing the foot member 20 from within the cane member 24. Once the foot member 20 is removed from the cane member 24, the first and second ends of the grip of the cane member can be removably attached to the upper portions of the first and second elongated members. The first and second ends can be removably attached using the bolt 26 and wing nut 28 combination, the spring-loaded device 32, or any other device or means of attachment known in the art.

The foot member 20 can then be telescopically inserted into the inner member 18 and the bottom portion of the cane member 24. Once inserted, the foot member 18 can be detachably connected to the bottom portion of the cane member 24 by inserting at least one spring-loaded pin 34 into at least one of the holes 25 in the cane member 24. Additionally, if the inner member 18 contains holes 35, then the spring-loaded pin(s) 34 may be inserted into the hole(s) 25 of the cane member 24 and the holes 35 of the inner member 18. Alternatively, the foot member 20 may be detachably connected to the bottom portion of the cane member 24 or inner member 18 using any other device or means of connecting known in the art.

When the present invention is intact as the crutch/cane assembly 10 or converted into the cane 60, the components described above are in substantial alignment along the vertical axis, and no component is required to be at an angle with the vertical axis.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following embodiments.

What is claimed is:

1. An adjustable crutch that converts into a cane, comprising:
a first elongated member and a second elongated member, each elongated member having an upper portion and a lower portion, the upper portions of the first and second elongated members in parallel alignment and separated by a grip, the upper portions connected to opposite ends of an arm support, the lower portions of the first and second elongated members having a converging pair of angular bends which bring the lower portions of the first and second elongated members into parallel alignment with an inner member;
the inner member connected to the lower portions of the first and second elongated members such that the lower portions of the first and second elongated members are on opposing sides of the inner member;
a removable cane member having a top portion and a bottom portion, the top portion including the grip, the grip having a first end and a second end, at least one of the first and second ends of the grip being removably attached to the upper portion of the first and second elongated members, the bottom portion of the removable cane member having at least one hole; and
an adjustable foot member telescopically inserted into the inner member and the removable cane member, the foot member having at least one spring-loaded pin and detachably connecting to the bottom portion of the cane member via the at least one spring-loaded pin that is inserted into the at least one hole in the bottom portion of the removable cane member.

2. The crutch according to claim 1, wherein the inner member has at least one hole.

3. The crutch according to claim 2, wherein the at least one hole in the inner member includes at least one pair of diametrically-opposed holes.

4. The crutch according to claim 2, wherein the at least one hole in the inner member includes alternating holes on opposing sides of the inner member.

5. The crutch according to claim 2, wherein the foot member detachably connects to the inner member via the at least one hole in the inner member.

6. The crutch according to claim 1, wherein the foot member includes a base.

7. The crutch according to claim 6, wherein the base is a single-pod foot.

8. The crutch according to claim 6, wherein the base is a multi-pod foot.

9. The crutch according to claim 6, wherein the base is made of rubber.

10. The crutch according to claim 1, wherein the grip is an orthopedic grip.

11. The crutch according to claim 1, wherein the grip is a cylindrical grip.

12. The crutch according to claim 1, wherein the grip is water resistant.

13. The crutch according to claim 1, wherein the grip is made of a durable, textured rubber material.

14. The crutch according to claim 2, wherein the at least one spring-loaded pin of the foot member is inserted into the at least one hole in the inner member.

15. The crutch according to claim 1, wherein the foot member and the removable cane member are detachably removable from the crutch.

16. The crutch according to claim 15, wherein the foot member and the removable cane member are detachably removable by disengaging the at least one spring-loaded pin.

17. The crutch according to claim 15, wherein the foot member is capable of being telescopically inserted into the removable cane member to form a cane.

18. The crutch according to claim 1, wherein the first and second ends of the grip are removably attached to the first and second elongated members via a bolt and wing nut combination.

19. The crutch according to claim 1, wherein at least one of the first and second ends of the grip are removably attached to the first and second elongated members via a spring-loaded device.

20. The crutch according to claim 1, wherein the at least one hole in the bottom portion of the removable cane member includes at least one pair of diametrically-opposed holes.

21. The crutch according to claim 1, wherein the at least one hole in the bottom portion of the removable cane member includes alternating holes on opposing sides of the cane member.

22. A method for converting an adjustable crutch into a cane, comprising:
providing a crutch/cane assembly having a first elongated member and a second elongated member, each elongated member having an upper portion and a lower portion, an arm support connected to the upper portions of the first and second elongated members, an inner member connected to the lower portions of the first and second elongated members such that the lower portions of the first and second elongated members are on opposite sides of the inner member, a removable cane member having a grip, the grip having a first end and a second end, at least one of the first and second ends of the grip being removably attached to the first and second elongated members, the removable cane member having at least one hole, and an adjustable foot member having at least one spring-loaded pin, the adjustable foot member telescopically inserted into the removable cane member and the inner member and connecting to the removable cane member via the at least one spring-loaded pin that is inserted into the at least one hole in the removable cane member;
removing the foot member from the crutch/cane assembly by releasing the at least one spring-loaded pin from the at least one hole in the removable cane member;
removing the cane member from the crutch/cane assembly by disengaging the grip of the removable cane member from the first and second elongated members; and
telescopically inserting the foot member into the cane member and attaching the foot member therein by inserting the at least one spring-loaded pin into the at least one hole in the cane member.

23. The method according to claim 22, wherein the inner member has at least one hole.

24. The method according to claim 23, wherein the at least one hole in the inner member includes at least one pair of diametrically-opposed holes.

25. The method according to claim 23, wherein the at least one hole in the inner member includes alternating holes on opposing sides of the inner member.

26. The method according to claim 23, wherein the adjustable foot member is connected to the inner member via the at least one spring-loaded pin that is inserted into the at least one hole contained in the inner member.

27. The method according to claim 23, further comprising removing the foot member from the crutch/cane assembly by releasing the at least one spring-loaded pin from the at least one hole in the inner member.

28. The method according to claim 22, wherein the foot member includes a base.

29. The method according to claim 28, wherein the base is a single-pod foot.

30. The method according to claim 28, wherein the base is a multi-pod foot.

31. The method according to claim 28, wherein the base is made of rubber.

32. The method according to claim 22, wherein the grip is an orthopedic grip.

33. The method according to claim 22, wherein the grip is a cylindrical grip.

34. The method according to claim 22, wherein the grip is water resistant.

35. The method according to claim 22, wherein the grip is made of a durable, textured rubber material.

36. The method according to claim 22, wherein the first and second ends of the grip are removably attached to the first and second elongated members via a bolt and wing nut combination.

37. The method according to claim 22, wherein at least one of the first and second ends of the grip are removably attached to the first and second elongated members via a spring-loaded device.

38. The method according to claim 22, wherein the at least one hole in the removable cane member includes at least one pair of diametrically-opposed holes.

39. The method according to claim 22, wherein the at least one hole in the removable cane member includes alternating holes on opposing sides of the cane member.

40. A crutch that converts into a cane, comprising:
a crutch component having a first elongated member and a second elongated member, each elongated member having an upper portion and a lower portion, an arm support connected to the upper portions of the first and second elongated members, an inner member connected to the lower portions of the first and second elongated members such that the lower portions of the first and second elongated members are on opposing sides of the inner member;
a removable cane component having a top portion and a bottom portion, the top portion having a grip, the grip having a first end and a second end, at least one of the first and second ends of the grip being removably attached to the upper portions of the first and second elongated members, the bottom portion of the removable cane component having at least one hole; and
a removable foot component capable of being telescopically inserted into the inner member and the cane component, and wherein the foot component has at least one spring-loaded pin and is detachably connected to the bottom portion of the cane component via the at least one spring-loaded pin that is inserted into the at least one hole in the bottom portion of the removable cane component.

41. The crutch according to claim 40, wherein the inner member has at least one hole.

42. The crutch according to claim 41, wherein the at least one hole in the inner member includes at least one pair of diametrically-opposed holes.

43. The crutch according to claim 41, wherein the at least one hole in the inner member includes alternating holes on opposing sides of the inner member.

44. The crutch according to claim 41, wherein the removable foot component is attached to the inner member by inserting the at least one spring-loaded pin into the at least one hole in the inner member.

45. The crutch according to claim 40, wherein the removable foot component includes a base.

46. The crutch according to claim 45, wherein the base is a single-pod foot.

47. The crutch according to claim 45, wherein the base is a multi-pod foot.

48. The crutch according to claim 45, wherein the base is made of rubber.

49. The crutch according to claim 40, wherein the grip is an orthopedic grip.

50. The crutch according to claim 40, wherein the grip is a cylindrical grip.

51. The crutch according to claim 40, wherein the grip is water resistant.

52. The crutch according to claim 40, wherein the grip is made of a durable, textured rubber material.

53. The crutch of according to claim 40, wherein the removable foot component and the removable cane component are detachably removable from the crutch.

54. The crutch according to claim 53, wherein the removable foot component and the removable cane component are detachably removable by disengaging the at least one spring-loaded pin.

55. The crutch according to claim 53, wherein the removable foot component is capable of being telescopically inserted into the removable cane component to form the cane.

56. The crutch according to claim 40, wherein the first and second ends of the grip are removably attached to the first and second elongated members via a bolt and wing nut combination.

57. The crutch according to claim 40, wherein at least one of the first and second ends of the grip are removably attached to the first and second elongated members via a spring-loaded device.

58. The crutch according to claim 40, wherein the at least one hole of the removable cane component includes at least one pair of diametrically-opposed holes.

59. The crutch according to claim 40, wherein the at least one hole of the removable cane component includes alternating holes on opposing sides of the removable cane component.

60. An adjustable crutch that converts into a cane, comprising:
a first elongated member and a second elongated member, each member having an upper portion and a lower portion;
an arm support connected to the upper portions of the first and second elongated members such that the upper portions are on opposing sides of the arm support;
an inner member connected to the lower portions of the first and second elongated members such that the lower portions are on opposing sides of the inner member;
a removable cane member having a top portion and a bottom portion, the top portion having a grip, the grip having a first end and a second end, at least one of the first and second ends of the grip being removably attached to the first and second elongated members by a removable attaching means, the bottom portion of the cane member having at least one hole; and
the inner member and the bottom portion of the cane member adapted for telescopically receiving a foot member, the foot member having means for detachably connecting the foot member to the bottom portion of the cane member.

61. A method for forming an adjustable crutch, comprising:
providing a first elongated member and a second elongated member, each member having an upper portion and a lower portion, the upper portions of the first and second elongated members connected to an arm support, the lower portions of the first and second elongated members connected to an inner member such that the lower portions of the first and second elongated members are on opposing sides of the inner member;
providing a cane member having a top portion and a bottom portion, the top portion including a grip having a first end and a second end, the bottom portion having at least one hole;
removably attaching at least one of the first and second ends of the grip of the cane member to the upper portions of the first and second elongated members;
telescopically inserting a foot member into the inner member and the bottom portion of the cane member; and
detachably connecting the foot member to the cane member.

62. A method for converting the adjustable crutch of claim 60 into a cane, comprising:
removing the cane member by releasing the removable attaching means to remove the grip from the first and second elongated members;
removing the foot member from the inner member and the cane member by releasing the means for detachably connecting the foot member to the bottom portion of the cane member; and
telescopically inserting the foot member into the cane member.

63. A crutch that converts into a cane, comprising:
a crutch component having first and second elongated members, the crutch component including an arm support connecting the first and second elongated members, the elongated members connecting on opposing sides to an inner member, the inner member having at least one hole; and
a removable cane component having a top portion and a bottom portion, the top portion including a grip having a first end and a second end, at least one of the first and second ends removably attached to the first and second elongated members by an attaching means, the bottom portion of the cane component having at least one hole; and
a removable foot component capable of being telescopically received by the inner member and the cane component.
